(19) United States
(12) Patent Application Publication
(10) Pub. No.: US 2025/0266891 A1
(43) Pub. Date: Aug. 21, 2025

(54) METHOD FOR BEAM MANAGEMENT

(71) Applicant: Nokia Technologies OY, Espoo (FI)

(72) Inventors: Keeth Saliya Jayasinghe LADDU, Espoo (FI); Mihai ENESCU, Espoo (FI); Kalle Petteri KELA, Kaarina (FI); Teemu Mikael VEIJALAINEN, Helsinki (FI)

(73) Assignee: Nokia Technologies OY, Espoo (FI)

(21) Appl. No.: 18/859,268

(22) PCT Filed: Mar. 21, 2023
(86) PCT No.: PCT/EP2023/057141

§ 371 Date: Oct. 23, 2024

(30) Foreign Application Priority Data
Apr. 29, 2022 (FI) 20225374

(51) Int. Cl. H04B 7/06; H04L 41/16; H04W 72/044

(52) U.S. Cl. CPC H04B 7/06952; H04B 7/0639; H04L 41/16; H04W 72/046

(57) ABSTRACT

An apparatus comprising means for transmitting an indication regarding capability of beam prediction in a spatial domain of the apparatus; means for receiving an indication of likelihood of the beams for at least one mode of beam prediction in spatial domain; means for measuring one or more reference signals from the beams to obtain a set of measurement results; means for using the measurement results as an input to a machine learning model and using likelihood of the beams, wherein the machine learning model is configured to use the input to produce an ordered list of the beams of the at least measured one or more reference signals; means for generating a channel state information report based on the ordered list of beams; and means for sending the report comprising indices of the beams of the ordered list.

### TECHNICAL FIELD

The present invention relates to beam management procedures, apparatuses and methods.

### BACKGROUND

The first release of the 5G-Advanced standard will be 3GPP Rel-18. One of the work items/study items (WI/SI) relates to Artificial Intelligence (AI)/Machine Learning (ML) for NR (New Radio) Air Interface. In this study, the goal is to explore the benefits of augmenting the air-interface with features enabling improved support of AI/ML based algorithms for enhanced performance and/or reduced complexity/overhead. Enhanced performance here depends on the considered use cases and could be, e.g., improved throughput, robustness, accuracy or reliability, etc.

With the NR beam measurement and reporting procedures, a user equipment (UE) reports the strongest beams but this procedure of selecting the strongest beams may often be associated with extra overhead and latency. Also, the NR beam reporting framework is not optimized for selecting the best beams for a 5G/NR base station (gNB) to improve overall cell-level throughput and reduce scheduling latency in more dynamic manner. In particular, the following issues can be identified:
Larger overhead: the gNB has to transmit a large number of reference signals such as Synchronization Signal Blocks (SSBs) and Channel State Information Reference Signals (CSI-RSs) to find the best beam towards the UE, which cause overhead concerns as each beam is associated to a different SSB or CSI-RS resource.
Higher latency: the time required for the gNB and UE to complete the beam sweeping and refinement to establish the best beam pair (transmit Tx and receive Rx) often happens based on multiple rounds of measurements (P1, P2, and P3 procedures).
Lower throughput & scheduling latency: gNB has a limitation when scheduling UEs as gNB may only be able to use one beam at a given time (e.g. time slot) which cause extra delays when supporting UEs within the cell and often results in overall throughput degradation.

### SUMMARY

Now, an improved method and technical equipment implementing the method has been invented, by which the above problems are alleviated. Various aspects include a method, an apparatus and a non-transitory computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided an apparatus comprising
means for transmitting an indication regarding capability of beam prediction in a spatial domain of the apparatus;
means for receiving an indication of likelihood of the beams for at least one mode of beam prediction in spatial domain;
means for receiving an indication of mode of beam prediction in spatial domain; means for measuring one or more reference signals from the beams to obtain a set of measurement results;
means for using the measurement results as an input to a machine learning model and using likelihood of the beams according to the mode of beam prediction in spatial domain, wherein the machine learning model is configured to use the input to produce an ordered list of the beams of the at least measured one or more reference signals; means for generating a channel state information report based on the ordered list of beams; and
means for sending the report comprising indices of the beams of the ordered list.

According to an embodiment, the apparatus comprises:
means for receiving two sets of RS indices with a first configuration defining a first set of RS indices of beams on which to perform signal measurements and a second configuration defining a second set of RS indices of beams to be considered in predictions;
means for measuring one or more reference signals from the beams of the first set to obtain a set of measurement results; and
means for using the measurement results as an input to a machine learning model and using likelihood of the beams according to the mode of beam prediction in spatial domain, wherein the machine learning model is configured to use the input to produce an ordered list of the beams of the first set and the second set.

According to an embodiment, the machine learning model of beam prediction in spatial domain is configured to construct the ordered list based on one or more of the following:
best strongest beams,
the best suited beams, or
the best beams with additional metric.

According to an embodiment, said means for generating a channel state information report are configured to include in the report one or more of the following:
beam indices,
beam receive quality indicators,
applicable UE panel indicators,
rank indicators,
precoding matrix indicators,
channel quality information, and
layer indicator.

According to an embodiment, the apparatus comprises means for receiving an update of a context for beam prediction in spatial domain.

According to an embodiment, the modes comprise at least the following:
best beam predictions in the spatial domain are beam predictions for the strongest beams,
best beam predictions in the spatial domain are beam predictions for the most efficient beams for scheduling.

According to an embodiment, the apparatus comprises means for updating the machine learning model; and means for sending the updated machine learning model to a network element.

An apparatus according to a second aspect comprises at least one processor and at least one memory, said at least one memory stored with computer program code thereon, the at least one memory and the computer program code configured to, with the at least one processor, cause the apparatus at least to perform:
transmit an indication regarding capability of beam prediction in a spatial domain of the apparatus;
receive an indication of likelihood of the beams for at least one mode of beam prediction in spatial domain;
receive an indication of mode of beam prediction in spatial domain;
measure one or more reference signals from the beams to obtain a set of measurement results;
use the measurement results as an input to a machine learning model and use likelihood of the beams according to the mode of beam prediction in spatial domain, wherein the machine learning model is configured to use the input to produce an ordered list of the beams of the at least measured one or more reference signals;
generate a channel state information report based on the ordered list of beams; and
send the report comprising indices of the beams of the ordered list.

A method according to a third aspect comprises:
transmitting an indication regarding capability of beam prediction in a spatial domain of the apparatus;
receiving an indication of likelihood of the beams for at least one mode of beam prediction in spatial domain;
receiving an indication of mode of beam prediction in spatial domain;
measuring one or more reference signals from the beams to obtain a set of measurement results;
using the measurement results as an input to a machine learning model and using likelihood of the beams according to the mode of beam prediction in spatial domain, wherein the machine learning model is configured to use the input to produce an ordered list of the beams of the at least measured one or more reference signals;
generating a channel state information report based on the ordered list of beams; and
sending the report comprising indices of the beams of the ordered list.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIG. 1 shows a schematic block diagram of an apparatus for incorporating a dual-SIM/MUSIM arrangement according to the embodiments;

FIG. 2 shows schematically a layout of an apparatus according to an example embodiment;

FIG. 3 shows a part of an exemplifying radio access network;

FIG. 4 depicts an example of gNB-UE signaling framework to enable ML-based beam prediction;

FIG. 5 shows an exemplary scenario of predicting the ranking of best beams at the UE;

FIG. 6 shows an example of how a scheduler uses ML based beam reporting from the UE, and updates the beam likelihood;

FIG. 7 illustrates some benefits of the beam likelihood information; and

FIG. 8 shows a flow chart for a beam management according to an embodiment.

### DETAILED DESCRIPTION OF SOME EXAMPLE EMBODIMENTS

The following describes in further detail suitable apparatus and possible mechanisms carrying out the beam scanning and mapping operations. While the following focuses on 5G networks, the embodiments as described further below are by no means limited to be implemented in said networks only, but they are applicable in any network supporting beam scanning and mapping operations.

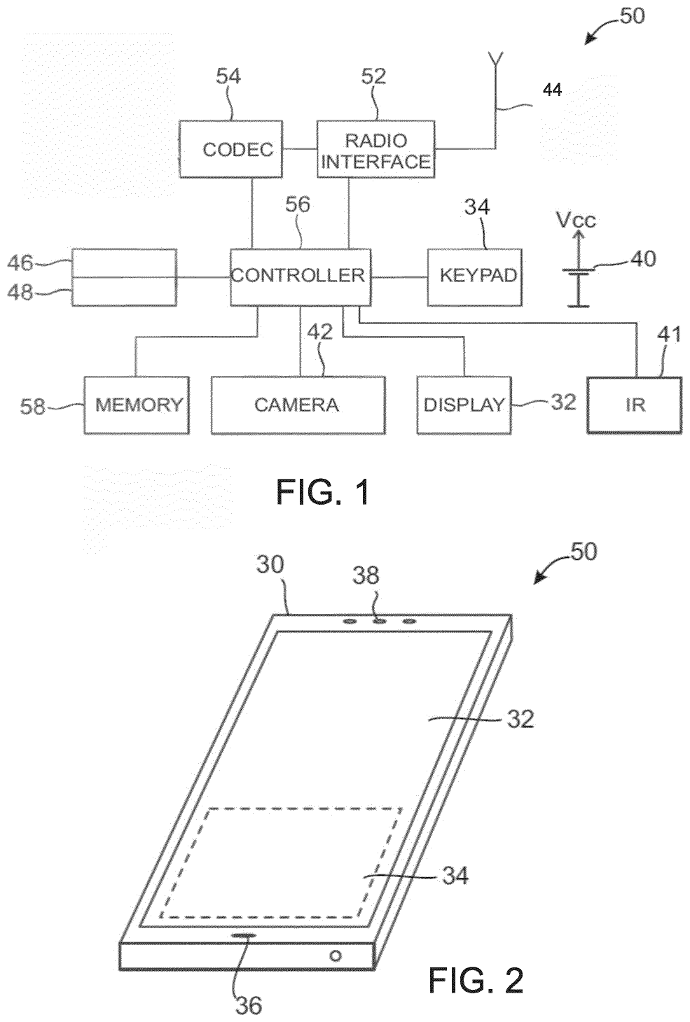

In this regard, reference is first made to FIGS. 1 and 2, where FIG. 1 shows a schematic block diagram of an exemplary apparatus or electronic device 50, which may incorporate the arrangement according to the embodiments. FIG. 2 shows a layout of an apparatus according to an example embodiment. The elements of FIGS. 1 and 2 will be explained next.

The electronic device 50 may for example be a mobile terminal or user equipment of a wireless communication system. The apparatus 50 may comprise a housing 30 for incorporating and protecting the device. The apparatus 50 further may comprise a display 32 and a keypad 34. Instead of the keypad, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device, such as anyone of: an earpiece 38, speaker, or an analogue audio or digital audio output connection. The apparatus 50 may also comprise a battery 40 (or the device may be powered by any suitable mobile energy device such as solar cell, fuel cell or clockwork generator). The apparatus may further comprise a camera 42 capable of recording or capturing images and/or video. The apparatus 50 may further comprise an infrared port 41 for short range line of sight communication to other devices. In other embodiments the apparatus 50 may further comprise any suitable short-range communication solution such as for example a Bluetooth wireless connection or a USB/firewire wired connection.

The apparatus 50 may comprise a controller 56 or processor for controlling the apparatus 50. The controller 56 may be connected to memory 58 which may store both user data and instructions for implementation on the controller 56. The memory may be random access memory (RAM) and/or read only memory (ROM). The memory may store computer-readable, computer-executable software including instructions that, when executed, cause the controller/processor to perform various functions described herein. In some cases, the software may not be directly executable by the processor but may cause a computer (e.g., when compiled and executed) to perform functions described herein. The controller 56 may further be connected to codec circuitry 54 suitable for carrying out coding and decoding of audio and/or video data or assisting in coding and decoding carried out by the controller.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In the following, different exemplifying embodiments will be described using, as an example of an access architecture to which the embodiments may be applied, a radio access architecture based on Long Term Evolution Advanced (LTE Advanced, LTE-A) or new radio (NR, 5G), without restricting the embodiments to such an architecture, however. A person skilled in the art appreciates that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof.

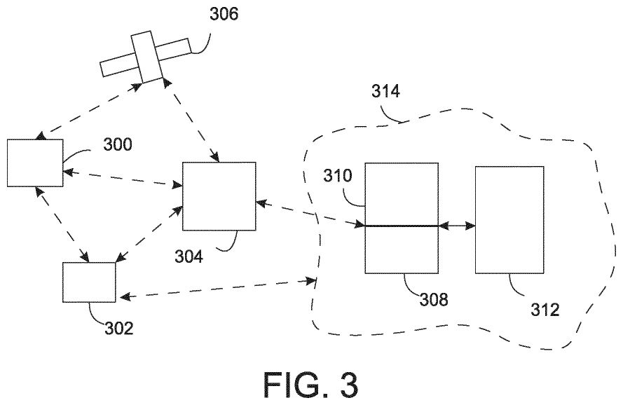

FIG. 3 depicts examples of simplified system architectures only showing some elements and functional entities, all being logical units, whose implementation may differ from what is shown. The connections shown in FIG. 3 are logical connections; the actual physical connections may be different. It is apparent to a person skilled in the art that the system typically comprises also other functions and structures than those shown in FIG. 3. The embodiments are not, however, restricted to the system given as an example but a person skilled in the art may apply the solution to other communication systems provided with necessary properties.

The example of FIG. 3 shows a part of an exemplifying radio access network.

FIG. 3 shows user devices 300 and 302 configured to be in a wireless connection on one or more communication channels in a cell with an access node (such as (e/g)NodeB) 304 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communication system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 310 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The CN may comprise network entities or nodes that may be referred to management entities. Examples of the network entities comprise at least an Access and Mobility Management Function (AMF).

The user device (also called a user equipment (UE), a user terminal, a terminal device, a wireless device, a mobile station (MS) etc.) illustrates one type of an apparatus to which resources on the air interface are allocated and assigned, and thus any feature described herein with a user device may be implemented with a corresponding network apparatus, such as a relay node, an eNB, and an gNB. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. Accordingly, the user device may be an IoT-device. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. The access nodes of the radio network form transmission/reception (TX/Rx) points (TRPs), and the UEs are expected to access networks of at least partly overlapping multi-TRPs, such as macro-cells, small cells, pico-cells, femto-cells, remote radio heads, relay nodes, etc. The access nodes may be provided with Massive MIMO antennas, i.e. very large antenna array consisting of e.g. hundreds of antenna elements, implemented in a single antenna panel or in a plurality of antenna panels, capable of using a plurality of simultaneous radio beams for communication with the UE. The UEs may be provided with MIMO antennas having an antenna array consisting of e.g. dozens of antenna elements, implemented in a single antenna panel or in a plurality of antenna panels. Thus, the UE may access one TRP using one beam, one TRP using a plurality of beams, a plurality of TRPs using one (common) beam or a plurality of TRPs using a plurality of beams.

The 4G/LTE networks support some multi-TRP schemes, but in 5G NR the multi-TRP features are enhanced e.g. via transmission of multiple control signals via multi-TRPs, which enables to improve link diversity gain. Moreover, high carrier frequencies (e.g., mmWaves) together with the Massive MIMO antennas require new beam management procedures for multi-TRP technology.

5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Frequency bands for 5G NR are separated into two frequency ranges: Frequency Range 1 (FR1) including sub-6 GHz frequency bands, i.e. bands traditionally used by previous standards, but also new bands extended to cover potential new spectrum offerings from 410 MHz to 7125 MHz, and Frequency Range 2 (FR2) including frequency bands from 24.25 GHz to 52.6 GHz. Thus, FR2 includes the bands in the mmWave range, which due to their shorter range and higher available bandwidth require somewhat different approach in radio resource management compared to bands in the FR1.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 312, or utilize services provided by them. The communication network may also be able to support the usage of cloud services, for example at least part of core network operations may be carried out as a cloud service (this is depicted in FIG. 3 by “cloud” 314). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU) and non-real time functions being carried out in a centralized manner (in a centralized unit, CU 308).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well. The gNB is a next generation Node B (or, new Node B) supporting the 5G network (i.e., the NR).

5G may also utilize non-terrestrial nodes 306, e.g. access nodes, to enhance or complement the coverage of 5G service, for example by providing backhauling, wireless access to wireless devices, service continuity for machine-to-machine (M2M) communication, service continuity for Internet of Things (IoT) devices, service continuity for passengers on board of vehicles, ensuring service availability for critical communications and/or ensuring service availability for future railway/maritime/aeronautical communications. The non-terrestrial nodes may have fixed positions with respect to the Earth surface or the non-terrestrial nodes may be mobile non-terrestrial nodes that may move with respect to the Earth surface. The non-terrestrial nodes may comprise satellites and/or HAPSs. Satellite communication may utilize geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node 304 or by a gNB located on-ground or in a satellite.

A person skilled in the art appreciates that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

The Radio Resource Control (RRC) protocol is used in various wireless communication systems for defining the air interface between the UE and a base station, such as eNB/gNB. This protocol is specified by 3GPP in in TS 36.331 for LTE and in TS 38.331 for 5G. In terms of the RRC, the UE may operate in LTE and in 5G in an idle mode or in a connected mode, wherein the radio resources available for the UE are dependent on the mode where the UE at present resides. In 5G, the UE may also operate in inactive mode. In the RRC idle mode, the UE has no connection for communication, but the UE is able to listen to page messages. In the RRC connected mode, the UE may operate in different states, such as CELL_DCH (Dedicated Channel), CELL_FACH (Forward Access Channel), CELL_PCH (Cell Paging Channel) and URA_PCH (URA Paging Channel). The UE may communicate with the eNB/gNB via various logical channels like Broadcast Control Channel (BCCH), Paging Control Channel (PCCH), Common Control Channel (CCCH), Dedicated Control Channel (DCCH), Dedicated Traffic Channel (DTCH).

The transitions between the states are controlled by a state machine of the RRC. When the UE is powered up, it is in a disconnected mode/idle mode. The UE may transit to RRC connected mode with an initial attach or with a connection establishment. If there is no activity from the UE for a short time, eNB/gNB may suspend its session by moving to RRC Inactive and can resume its session by moving to RRC connected mode. The UE can move to the RRC idle mode from the RRC connected mode or from the RRC inactive mode.

The actual user and control data from network to the UEs is transmitted via downlink physical channels, which in 5G include Physical downlink control channel (PDCCH) which carries the necessary downlink control information (DCI), Physical Downlink Shared Channel (PDSCH), which carries the user data and system information for user, and Physical broadcast channel (PBCH), which carries the necessary system information to enable a UE to access the 5G network.

The user and control data from UE to the network is transmitted via uplink physical channels, which in 5G include Physical Uplink Control Channel (PUCCH), which is used for uplink control information including HARQ feedback acknowledgments, scheduling request, and downlink channel-state information for link adaptation, Physical Uplink Shared Channel (PUSCH), which is used for uplink data transmission, and Physical Random Access Channel (PRACH), which is used by the UE to request connection setup referred to as random access.

In the following, an enhanced method for beam for AI/ML aided beam prediction in spatial domain for multi-criterion beam optimization will be described in more detail, in accordance with various embodiments.

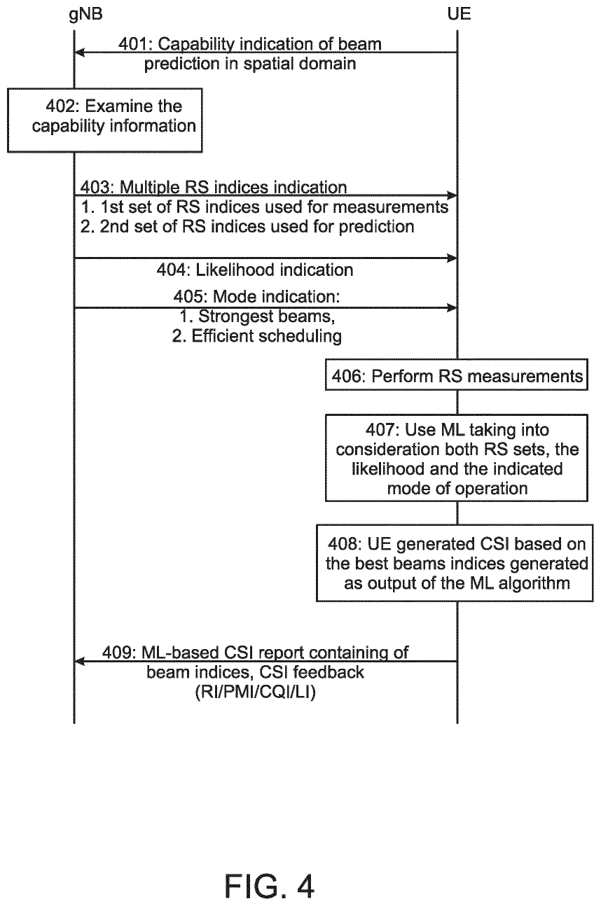

FIG. 4 illustrates as a simplified signalling diagram procedures performed between a user equipment UE and a base station gNB according to an embodiment of the disclosure. The UE reports 401 to the gNB an indication regarding capability of beam prediction in a spatial domain of the UE. The capability of beam prediction in spatial domain of applying a trained machine learning (ML) model may comprise one or more of the following aspects.

According to one aspect the UE is able to measure one set of indicated reference signals (RSs) and use those measurements as an input of a trained ML model to predict best beams (reference signals indices, RS indices), where the best beams derived from beam prediction, which is an output of the ML model, can contain beams from both one set of reference signals and another set of reference signals. The another set of RSs may be indicated and/or known explicitly or implicitly to the UE but not being measured by the UE.

The UE may further indicate the capability of option 1 and/or option 2.

In the option 1, the UE is able to apply the trained ML model for beam prediction in spatial domain in different contexts, where contexts contain at least the following.
Mode 1: “Best beams” predictions in the spatial domain are understood as the beam predictions for the strongest beams. In this context, the strongest beams are those beams with the highest layer 1 received signal received power (L1-RSRP) or layer 1 signal to noise and interference ratio (L1-SINR)
Mode 2: “Best beams” predictions in the spatial domain are understood as the predictions for the most efficient beams for scheduling. In this context, such beams are those which may allow faster scheduling and are not necessarily the strongest beams from power perspective (e.g. LI-RSRP, LI-SINR).

The ML model for beam prediction can be switched from one mode to the other mode with or without extra latency, and the ML model may not have any additional training, validation, or testing stages associated when switching the mode of operation.

In the option 2, which is a variant for option 1, the UE is able to apply the trained ML model for beam prediction in spatial domain which is also providing at least one additional output metric associated with each best beam, where the metric may allow identifying a strongest beam and/or a most efficient beam.

The UE may further indicate limitations and/or restrictions or capabilities of ML model input/output parameters, dimensions, and other related aspects, where input parameters at least contain considering at least one additional parameter that is related to the likelihood of the beams (possibility of using the beam by the gNB or statistics related to usage of the beams) of one set of RSs and/or another set of RSs.

The gNB receives the capability indication and examines 402 the content of the capability indication and may perform the following.

According to the reported UE capability, the gNB may determine a trained ML model for beam prediction in spatial domain and based on the determination, configure the UE to use the trained ML model.

According to one aspect, the ML model may be trained, for example, offline at the gNB, wherein the trained model may be transferred to the UE after training. According to another aspect, the ML model may be trained offline at the UE. The ML model may be having continuous learning procedures and may be trained at either gNB or UE. If it is trained at the gNB, updates on the ML model may be sent to the UE. Any other collaboration modes for model deployment may also be feasible.

The gNB may then send 403 to the UE one or more configurations that define two sets of RS indices, where the first set of RS indices is comprising of measurement resources i.e. a set of beams on which to perform actual signal measurements, and the second set of RS indices is used for prediction resources i.e. a set of beams to be considered in the predictions.

The indication of the two sets of RS indices may happen explicitly (e.g. via RRC configuration, medium access control control element (MAC-CE) indication) or implicitly (e.g. based on a predefined set of rules in the specification where the two sets of RS indices are linked to each other).

In accordance with an embodiment, the gNB may select the RS indices to be included in the first set and in the second set based, for example, a determined direction of the UE with respect to the gNB. Hence, the selection of the beams may be performed among those beams which are directed to the UE and beams which are directed slightly aside the direction of the UE may be selected to the first set and the second set. Therefore, beams which are directed to a totally different direction i.e. away from the UE may not be selected to the first set nor the second set. Hence, some unnecessary computing efforts may be avoided.

The gNB may also send 404 to the UE a configuration and/or an indication which defines or updates at least one parameter related to the likelihood of the beams for the first set of RSs and/or second set of RSs. The likelihood of the beams means in this context a possibility of using the beam by the gNB or statistics related to usage of the beams.

In accordance with an embodiment of the disclosure, the likelihood of the beams can be configured within the same configuration that configures the first set of RSs and/or the second set of RSs. For example, if the first set of RSs and the second set of RSs are configuring as resourcesForChannelMeasurement sets in a channel state information (CSI) reporting configuration, likelihood values can be associated with resources in each resourcesForChannelMeasurement sets.

In accordance with another embodiment of the disclosure, the likelihood of the beams can be updated by dynamic signaling (e.g. via medium access control control element (MAC-CE) for the first set of RSs and/or the second set of RSs, or in a generic manner for the RS level. For example, MAC-CE can update the likelihood values of one or more RSs, where MAC-CE is designed dedicated for that purpose.

The beam likelihood information can include the following information:
Measured or expected beam usage information in time-domain over certain time window. In other words, how many times a beam have been scheduled, or is expected to be scheduled, during the time window, divided by all scheduling counts.
Measured or expected RB (Resource Block) load per beam. This allows the ML model to understand if the UE traffic can be offloaded to a certain beam or if the UE should be offloaded away from a beam.
Priority of a beam. The UE can be made aware if the gNB prioritizes certain beams due to higher priority users. This allows the ML model to understand which of the beams would be more likely to be scheduled first.

When the configurations of the first and the second RS sets and applicable likelihood of beams are received at the UE, the UE may apply the trained model based on one of the following ways.

According to a first option, if the UE is able to apply the trained ML model in different contexts, the gNB may also send 405 to the UE a configuration or indication to use either Mode 1 or Mode 2 for the beam prediction. If the Mode 1 Strongest Beam is applied to the beam prediction, the UE may use equal values for the likelihood of beams in the input of the ML model, where the predicted outcome represents the strongest beams (the beams with highest L1-RSRP or L1-SINR) and not biased by the configured/updated likelihood of beams. If the Mode 2 Efficient Scheduling is applied to the beam prediction, the UE may use the latest values for the likelihood of beams in the input of the ML model, where the predicted outcome represents the best suited beams (the beams which may allow faster scheduling and not necessarily to be the strongest beams) and biased by the configured/updated likelihood of beams.

According to a second option, the gNB providing at least one additional output metric associated with each best beam, the UE may use the latest values for the likelihood of beams in the input of the ML model, and the predicted outcome may provide the best beams with additional metric for each beam, where the metric allows identifying a strongest beam and a most suited beam.

When the UE has received the above messages from the gNB, the UE may perform 406 signal strength measurements (RS measurements) of the first set of indicated reference signals (RSs) and use results of those measurements as an input of a trained ML model. The UE also uses the likelihood and the indicated mode of operation as additional inputs to the ML model. The ML model also takes into consideration both the first set of indicated reference signals and the second set of indicated reference signals.

When the UE has executed 407 the ML model to obtain a result, the output of the trained ML model may be an ordered list of at least a part of the beams of the first set and the second set, the ordering being based on a predetermined criteria. In accordance with an embodiment, the criteria comprises one or more of the following: the best strongest beams, the best suited beams, or the best beams with additional metric. As an example, the ordered list may comprise beams indices of all the beams of the first set and the second set ordered so that the best suited beam is ranked highest and the least suited beam is ranked the lowest. The best suited may mean, for example, the beam which most probably provides least latency, least power consumption, the most efficient channel utilization, least interference, etc.

The output from the ML model is used by the UE to generate 408 a channel state information (CSI) report, in which the best beams are reported 409 to the gNB. The CSI report may comprise beam indices (CSI-RS resource indicator (CRI) and/or SSB resource indicator (SSBRI) with or without L1-RSRP/L1-SINR) and CSI feedback i.e. rank indicators (RI)/precoding matrix indicators (PMI)/channel quality information (CQI)/layer indicator (LI).

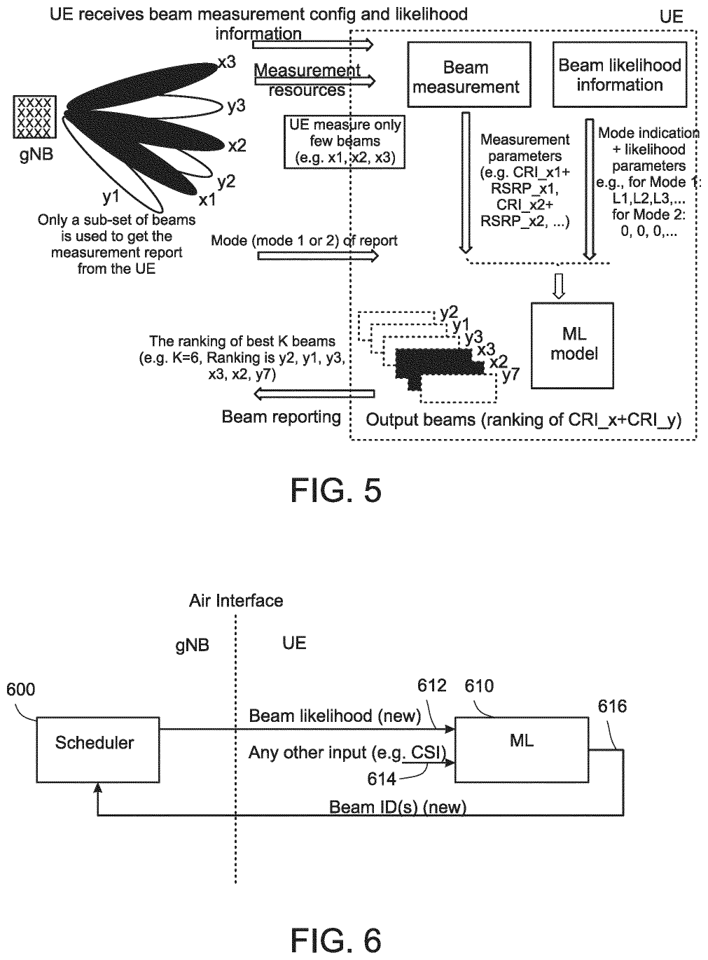

In the following an exemplary scenario will be described in more detail with reference to FIG. 5. In this scenario a sub-set of narrow beam measurements are used to predict the ranking of the best narrow beams at the UE.

The gNB decides to select the beams marked as x1, x2, x3 for measurements and some other beams marked as y1, y2, y3 for predictions. The gNB sends the configurations i.e. the first set of RS indices containing the RS indices of the beams x1, x2 and x3, and the second set of RS indices containing the RS indices of the beams y1, y2 and y3. Hence, the UE gets a configuration that defines the first subset of beams x1, x2 and x3 for measurements and the second sub-set of beams y1, y2, and y3 for predictions. The UE further receives likelihood information, which may be marked as L1, L2, L3, . . . for mode 1 (the strongest beam) and 0, 0, 0 . . . for mode 2 (efficient scheduling), related to each beam and the mode of operation (e.g. either mode 1 or mode 2) to consider in the beam prediction. As shown in FIG. 5, the UE uses the measurement results of those beams which are indicated as RS indices in the first set, corresponding L1-RSRP values, and likelihood values corresponding to the indicated mode as the inputs of the ML model. In this example, the UE executes the ML model prediction locally and provides a list of CRI associated with K beams. As shown in FIG. 5, the list comprises both measured beams (solid filling) and predicted beams (empty filling), which are ranked, for instance, in descending order from the most likely best beam (e.g., for mode 1, most likely strongest beams) to the less likely best beam (e.g., for mode 1, less likely strongest beams). Finally, the list of ranked beams is added to the beam reporting uplink control information to send back to the gNB.

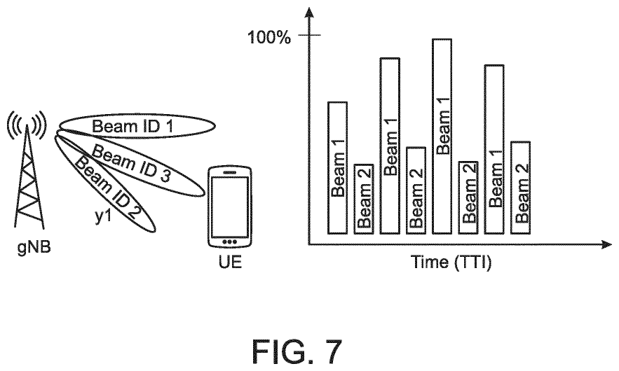

FIGS. 6 and 7 are demonstrating an example implementation for ML 610 at the UE side predicting the best beam for scheduling with the help of beam likelihood information (Option-1, mode-2).

The input for the ML model 610 is beam likelihood information 612 from the gNB, and UE's internal channel measurements 614. The prediction 616 is then used as feedback to the network influencing to the gNBs spatial beam selection/scheduling.

Some potential benefits of the above-described beam likelihood information are demonstrated with FIG. 7. In this example the UE is measuring the beam ID 3 to be the strongest beam. With a baseline implementation, the UE would feedback the strongest beams part of the CSI feedback, and the gNB would then schedule UE with the strongest beam. By doing so, a scheduling delay of all the UEs would increase, since a new beam would have to be scheduled in time domain sharing the resources with the two other beams.

However, the beam likelihood information provides the necessary information for the UE to estimate the best beam for the scheduler 600, to improve throughput and/or latency. The example shows that beams ID 1 and ID 2 are equally scheduled in time domain, while the beam ID 1 is having higher residual block (RB) load than the beam ID 2. This information may be signaled for the UE as a part of the beam likelihood information e.g. as follows:
Beam ID 1: 50% scheduling probability & 60% RB load
Beam ID 2: 50% scheduling probability & 30% RB load
Beam ID 3: 0% scheduling probability & 0 & RB load

With this information, together with UE's internal channel measurements, the ML model can understand the following situations
how much radio resources are needed to schedule the user per beam (UEs channel measurements)
how much there are available radio resources per beam (RB load)
what would be the scheduling delay based on the likelihood of a beam (scheduling probability)

As a conclusion, the UE's ML model may infer that it is better to suggest for the gNB to be scheduled at beam ID 2, rather than exploiting the strongest beam. Consequently, not only the user running the ML would benefit from shorter delay, but potentially other UEs as well may be benefiting from this situation since a new beam doesn't have to be scheduled in time domain.

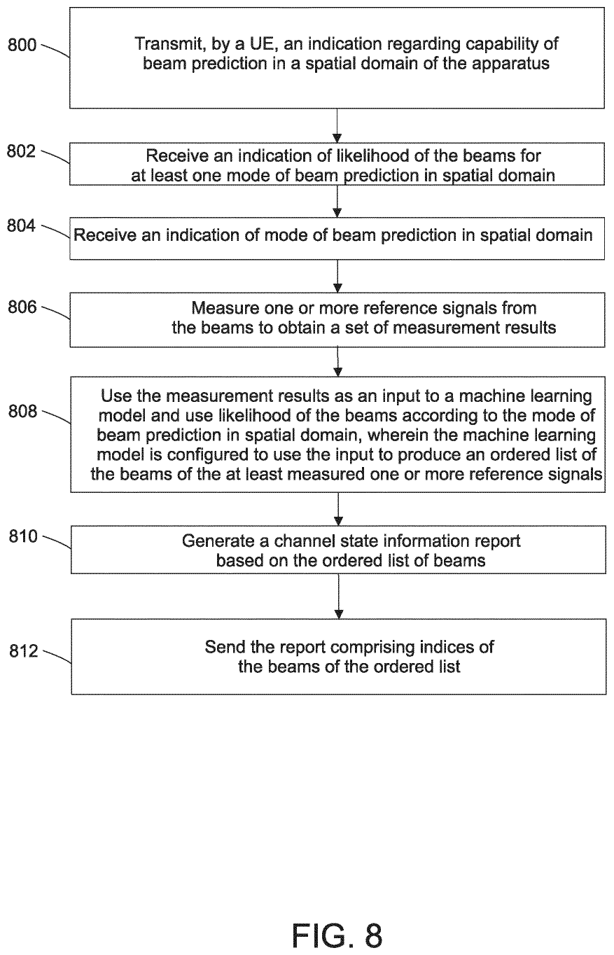

The method, which is disclosed in flow chart of FIG. 8 as reflecting the operation of a terminal apparatus, such as a user equipment (UE), wherein the method comprises transmitting (800), by a user equipment, an indication regarding capability of beam prediction in a spatial domain of the apparatus; receiving (802) an indication of likelihood of the beams for at least one mode of beam prediction in spatial domain; receiving (804) an indication of mode of beam prediction in spatial domain; measuring (806) one or more reference signals from the beams to obtain a set of measurement results; using (808) the measurement results as an input to a machine learning model and using likelihood of the beams according to the mode of beam prediction in spatial domain, wherein the machine learning model is configured to use the input to produce an ordered list of the beams of the at least measured one or more reference signals; generating (810) a channel state information report based on the ordered list of beams; and sending (812) the report comprising indices of the beams of the ordered list.

According to an embodiment, the method comprises receiving two sets of RS indices with a first configuration defining a first set of RS indices of beams on which to perform signal measurements and a second configuration defining a second set of RS indices of beams to be considered in predictions; measuring one or more reference signals from the beams of the first set to obtain a set of measurement results; and using the measurement results as an input to a machine learning model and using likelihood of the beams according to the mode of beam prediction in spatial domain, wherein the machine learning model is configured to use the input to produce an ordered list of the beams of the first set and the second set.

According to an embodiment, the machine learning model is configured to construct the ordered list based on one or more of the following: best strongest beams, the best suited beams, or the best beams with additional metric.

According to an embodiment, the method comprises using in the best strongest beams mode equal values for the likelihood of beams in the input of the machine learning model, where the predicted outcome represents the strongest beams, and using in the best suited beams mode latest values for the likelihood of beams in the input of the machine learning model, where the predicted outcome represents the best suited beams.

According to an embodiment, the method comprises including in the report one or more of the following:
beam indices,
rank indicators,
precoding matrix indicators,
channel quality information, and
layer indicator
receive quality of the beam (L1-RSRP/L1-SINR)
applicable UE panel indicators.

According to an embodiment, the method comprises receiving an indication of a context for beam prediction in spatial domain.

According to an embodiment, the modes comprise at least the following:
best beam predictions in the spatial domain are beam predictions for the strongest beams,
best beam predictions in the spatial domain are beam predictions for the most efficient beams for scheduling.

According to an embodiment, the method comprises updating the machine learning model; and sending the updated machine learning model to a network element.

According to an embodiment, the beam likelihood information includes one or more of the following information:
measured or expected beam usage information in time-domain over a certain time window,
measured or expected resource block load per beam,
priority of a beam.

According to an embodiment, the method comprises updating the likelihood of the beams by dynamic signalling for at least one of the first set of RS indices and/or the second set of RS indices.

According to an embodiment, the method comprises switching the machine learning model for beam prediction from one mode to another mode.

According to an embodiment, the method comprises performing the switching the mode of operation without any additional training, validation, or testing stages.

According to an embodiment, the method comprises indicating limitations, restrictions or capabilities of the machine learning model input/output parameters, dimensions, and other related aspects, where the input parameters at least comprise considering at least one additional parameter that is related to the likelihood of the beams.

According to an embodiment, the method comprises receiving the likelihood information, which may be marked as L1, L2, L3, . . . for mode 1 (the strongest beam) and 0, 0, 0 . . . for mode 2 (efficient scheduling), related to each beam and the mode of operation (e.g. either mode 1 or mode 2) to consider in the beam prediction.

An apparatus, such as a UE, according to an aspect comprises means for transmitting an indication regarding capability of beam prediction in a spatial domain of the apparatus; means for receiving an indication of likelihood of the beams for at least one mode of beam prediction in spatial domain; means for receiving an indication of mode of beam prediction in spatial domain; means for measuring one or more reference signals from the beams to obtain a set of measurement results; means for using the measurement results as an input to a machine learning model and using likelihood of the beams according to the mode of beam prediction in spatial domain, wherein the machine learning model is configured to use the input to produce an ordered list of the beams of the at least measured one or more reference signals; means for generating a channel state information report based on the ordered list of beams; and means for sending the report comprising indices of the beams of the ordered list.

An apparatus according to a further aspect comprises a plurality of antenna panels, at least one processor and at least one memory, said at least one memory stored with computer program code thereon, the at least one memory and the computer program code configured to, with the at least one processor, cause the apparatus at least to perform: transmit an indication regarding capability of beam prediction in a spatial domain of the apparatus; receive an indication of likelihood of the beams for at least one mode of beam prediction in spatial domain; receive an indication of mode of beam prediction in spatial domain; measure one or more reference signals from the beams to obtain a set of measurement results; use the measurement results as an input to a machine learning model and use likelihood of the beams according to the mode of beam prediction in spatial domain, wherein the machine learning model is configured to use the input to produce an ordered list of the beams of the at least measured one or more reference signals; generate a channel state information report based on the ordered list of beams; and send the report comprising indices of the beams of the ordered list.

A further aspect relates to a computer program product, stored on a non-transitory memory medium, comprising computer program code, which when executed by at least one processor, causes an apparatus at least to perform: transmit an indication regarding capability of beam prediction in a spatial domain of the apparatus; receive an indication of likelihood of the beams for at least one mode of beam prediction in spatial domain; receive an indication of mode of beam prediction in spatial domain; measure one or more reference signals from the beams to obtain a set of measurement results; use the measurement results as an input to a machine learning model and use likelihood of the beams according to the mode of beam prediction in spatial domain, wherein the machine learning model is configured to use the input to produce an ordered list of the beams of the at least measured one or more reference signals; generate a channel state information report based on the ordered list of beams; and send the report comprising indices of the beams of the ordered list.

According to an embodiment, the apparatus comprises computer program code configured to cause the apparatus to perform: receive two sets of RS indices with a first configuration defining a first set of RS indices of beams on which to perform signal measurements and a second configuration defining a second set of RS indices of beams to be considered in predictions; measure one or more reference signals from the beams of the first set to obtain a set of measurement results; and use the measurement results as an input to a machine learning model and use likelihood of the beams according to the mode of beam prediction in spatial domain, wherein the machine learning model is configured to use the input to produce an ordered list of the beams of the first set and the second set.

According to an embodiment, the apparatus comprises computer program code configured to cause the apparatus to perform: construct the ordered list by the machine learning model of beam prediction in spatial domain based on one or more of the following:
best strongest beams,
the best suited beams, or
the best beams with additional metric.

According to an embodiment, the apparatus comprises computer program code configured to cause the apparatus to perform:
use in the best strongest beams mode equal values for the likelihood of beams in the input of the machine learning model, where the predicted outcome represents the strongest beams,
use in the best suited beams mode latest values for the likelihood of beams in the input of the machine learning model, where the predicted outcome represents the best suited beams.

According to an embodiment, the apparatus comprises computer program code configured to cause the apparatus to perform: include in the channel state information report one or more of the following:
beam indices,
beam receive quality indicators,
applicable UE panel indicators,
rank indicators,
precoding matrix indicators,
channel quality information, and
layer indicator.

According to an embodiment, the apparatus comprises computer program code configured to cause the apparatus to perform:
receive an indication update of a context for beam prediction in spatial domain.

According to an embodiment, the apparatus comprises computer program code configured to cause the apparatus to perform:
update the machine learning model; and
send the updated machine learning model to a network element.

According to an embodiment, the apparatus comprises computer program code configured to cause the apparatus to perform:
include in the beam likelihood information one or more of the following information:
   measured or expected beam usage information in time-domain over a certain time window,
   measured or expected resource block load per beam,
   priority of a beam.

According to an embodiment, the apparatus comprises computer program code configured to cause the apparatus to perform:
update the likelihood of the beams by dynamic signalling for at least one of the first set of RS indices and/or the second set of RS indices.

According to an embodiment, the apparatus comprises computer program code configured to cause the apparatus to perform:
switch the machine learning model for beam prediction from one mode to another mode.

According to an embodiment, the apparatus comprises computer program code configured to cause the apparatus to perform the switching of the mode of operation without any additional training, validation, or testing stages.

According to an embodiment, the apparatus comprises computer program code configured to cause the apparatus to perform:
indicate limitations, restrictions or capabilities of the machine learning model input/output parameters, dimensions, and other related aspects, where the input parameters at least comprises considering at least one additional parameter that is related to the likelihood of the beams.

According to an embodiment, the apparatus comprises computer program code configured to cause the apparatus to perform:
receive the likelihood information for mode 1 and for mode 2, related to each beam and the mode of operation to be considered in the beam prediction.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1. (canceled)

2. (canceled)

3. The apparatus according to claim 15, wherein the machine learning model of beam prediction in spatial domain is configured to construct the ordered list based on one or more of the following:
best strongest beams,
the best suited beams, or
the best beams with additional metric.

4. The apparatus according to claim 3, said at least one memory stored with computer program code thereon, the at least one memory and the computer program code configured to, with the at least one processor, cause the apparatus at least to perform:
using in the best strongest beams mode equal values for the likelihood of beams in the input of the machine learning model, where the predicted outcome represents the strongest beams,
using in the best suited beams mode latest values for the likelihood of beams in the input of the machine learning model, where the predicted outcome represents the best suited beams.

5. The apparatus according to claim 15, said at least one memory stored with computer program code thereon, the at least one memory and the computer program code configured to, with the at least one processor, cause the apparatus at least to perform:
including in the report one or more of the following:
beam indices,
beam receive quality indicators,
applicable UE panel indicators,
rank indicators,
precoding matrix indicators,
channel quality information, and
layer indicator.

6. The apparatus according to claim 15, said at least one memory stored with computer program code thereon, the at least one memory and the computer program code configured to, with at least one processor, cause the apparatus at least to perform:
receiving an update of a context for beam prediction in spatial domain.

7. The apparatus according to claim 6, wherein the modes comprise at least the following:
best beam predictions in the spatial domain are beam predictions for the strongest beams,
best beam predictions in the spatial domain are beam predictions for the most efficient beams for scheduling.

8. The apparatus according to claim 15, said at least one memory stored with computer program code thereon, the at least one memory and the computer program code configured to, with the at least one processor, cause the apparatus at least to perform:
updating the machine learning model; and
sending the updated machine learning model to a network element.

9. The apparatus according to claim 15, wherein the beam likelihood information includes one or more of the following information:
measured or expected beam usage information in time-domain over a certain time window,
measured or expected resource block load per beam,
priority of a beam.

10. The apparatus according to claim 15, said at least one memory stored with computer program code thereon, the at least one memory and the computer program code configured to, with the at least one processor, cause the apparatus at least to perform:
updating the likelihood of the beams by dynamic signalling for at least one of the first set of RS indices and/or the second set of RS indices.

11. The apparatus according to claim 15, said at least one memory stored with computer program code thereon, the at least one memory and the computer program code configured to, with the at least one processor, cause the apparatus at least to perform:
switching the machine learning model for beam prediction from one mode to another mode.

12. The apparatus according to claim 11, said at least one memory stored with computer program code thereon, the at least one memory and the computer program code configured to, with the at least one processor, cause the apparatus at least to perform the switching of the mode of operation without any additional training, validation, or testing stages.

13. The apparatus according to claim 15, said at least one memory stored with computer program code thereon, the at least one memory and the computer program code configured to, with the at least one processor, cause the apparatus at least to perform:
indicating limitations, restrictions or capabilities of the machine learning model input/output parameters, dimensions, and other related aspects, where the input parameters at least comprises considering at least one additional parameter that is related to the likelihood of the beams.

14. The apparatus according to claim 15, said at least one memory stored with computer program code thereon, the at least one memory and the computer program code configured to, with the at least one processor, cause the apparatus at least to perform:
receiving the likelihood information for mode 1 and for mode 2, related to each beam and the mode of operation to be considered in the beam prediction.

15. An apparatus comprising at least one processor and at least one memory, said at least one memory stored with computer program code thereon, the at least one memory and the computer program code configured to, with the at least one processor, cause the apparatus at least to perform:
transmit an indication regarding capability of beam prediction in a spatial domain of the apparatus;
receive an indication of likelihood of the beams for at least one mode of beam prediction in spatial domain;
receive an indication of mode of beam prediction in spatial domain;
measure one or more reference signals from the beams to obtain a set of measurement results;
use the measurement results as an input to a machine learning model and use likelihood of the beams according to the mode of beam prediction in spatial domain, wherein the machine learning model is configured to use the input to produce an ordered list of the beams of the at least measured one or more reference signals;
generate a channel state information report based on the ordered list of beams; and
send the report comprising indices of the beams of the ordered list.

16. The apparatus according to claim 15, said at least one memory stored with computer program code thereon, the at least one memory and the computer program code configured to, with the at least one processor, cause the apparatus at least to perform:
receive two sets of RS indices with a first configuration defining a first set of RS indices of beams on which to perform signal measurements and a second configuration defining a second set of RS indices of beams to be considered in predictions;
measure one or more reference signals from the beams of the first set to obtain a set of measurement results; and
use the measurement results as an input to a machine learning model and using likelihood of the beams according to the mode of beam prediction in spatial domain, wherein the machine learning model is configured to use the input to produce an ordered list of the beams of the first set and the second set.
